(19) United States
(12) Patent Application Publication
(10) Pub. No.: US 2014/0146043 A1
(43) Pub. Date: May 29, 2014

(54) METHOD AND DEVICE FOR ENCODING AN ORIENTATION VECTOR OF A CONNECTED COMPONENT, CORRESPONDING DECODING METHOD AND DEVICE AND STORAGE MEDIUM CARRYING SUCH ENCODED DATA

(71) Applicants: Wenfei Jiang, Beijing (CN); Kangying Cai, Beijing (CA); Jiang Tian, Beijing (CN)

(72) Inventors: Wenfei Jiang, Beijing (CN); Kangying Cai, Beijing (CA); Jiang Tian, Beijing (CN)

(73) Assignee: Thomson Licensing, Issy de Moulineaux (FR)

(21) Appl. No.: 14/233,595

(22) PCT Filed: Jul. 17, 2012
(86) PCT No.: PCT/CN2012/078750

§ 371 Date: Jan. 17, 2014

(30) Foreign Application Priority Data
Jul. 18, 2011 (WO) CN2011/077277
Jul. 17, 2012 (WO) CN2012/078750

(51) Int. Cl. G06T 9/00

(52) U.S. Cl. CPC G06T 9/00
USPC 345/419

(57) ABSTRACT

The invention is made in the field of encoding and decoding at least one orientation vector of a connected component. When quantizing vector components for encoding, an acceptable quantization deviation of encoded vector components sometimes leads to unacceptable deviations of calculated vector components. Therefore, a method is proposed which comprises quantizing and de-quantizing a first and a second component of the vector, and encoding the quantized first and second component and a bit signalling the sign of a third component of said vector, using the pre-determined length and the de-quantized first and second component for determining whether a calculated absolute of an approximation of the third component of said vector is smaller than a first threshold, and, if the calculated absolute is smaller than the first threshold, determining, quantizing and encoding a residual between the calculated absolute of the third component and the absolute of the third component.

### TECHNICAL FIELD

The invention is made in the field of encoding of components of vectors. In particular, the invention is concerned with encoding of an orientation vector of a connected component, said vector having a pre-determined length and comprising three components.

### BACKGROUND OF THE INVENTION

Orientation vectors of connected components serve for rotational transformation of a template of the component into an instance of the component and are used in many different ways in processing of audiovisual content. For instance, when modelling aural objects the object may represent a sound source. When modelling visual objects the object may represent a rigid body.

When modelling visual objects, in particular in three dimensions (3D) for use in e.g. CAD systems, 3D games, 3D TV or 3D cinema, to name a few, often repetitive structures are encountered. Such repetitive structures, e.g. objects or object-parts which occur several times, can be compress encoded by encoding a template of the structure once and encoding, for each instance of the structure, data allowing for transformation of the template into the instance. Templates are also called patterns and can result from clustering.

Most generally speaking, such transformation is an affine transformation which can be decomposed into rotation, scaling, shear and/or displacement. Rotation, scaling, shear are linear transformations which are commutative, i.e. order of their application does not affect the overall transformation result, and data allowing for each of the linear transformation can be encoded independently.

Among the linear transformations, rotations in ordinary three-dimensional space can be further decomposed into rotations around three different axes, i.e. rotational data of rotations in 3D in general has three degrees of freedom.

That is, the rotational transformation part of the affine transformation can be represented by parameters specifying a pair of normalized orientation vectors orthogonal to each other. Due to the perpendicularity constraint and the normality constraints this pair of orientation vectors has three degrees of freedom, i.e. three parameters have to be determined in order to allow unequivocally determination of the two vectors since the other parameters can be calculated using the encoded parameters and the constraints.

In case of so-called gimbal lock where a specific one of the rotations is Zero or π (also written as Pi, corresponding to 180°), precession rotation and intrinsic rotation occur around a same axis, i.e. in a same plane. Then precession rotation and intrinsic rotation are commutative and can be represented by a cumulated rotation. Thus, in such case a degree of freedom is lost and the rotation is uniquely specified by two parameters.

M. Deering: “Geometry Compression”, Proceedings of ACM SIGGRAPH, 1995, pp. 13-20, proposed, for encoding of orientation vectors, a normal sphere on which the end points of unit normal lie and which is divided into eight octants, each octant being further divided into six sextants.

For the cases where orientation axes of the connected components have some dominate orientations, Deok-Soo Kim, Youngsong Cho and Hyun Kim: “Normal Compression Based on Clustering and Relative Indexing”, Pacific Conference on Computer Graphics and Applications IEEE, 2002, propose an approach based on k-means clustering with a fixed number of clusters.

Another approach towards exploiting repetitive patterns for compression is described in Kangying Cai, Wencheng Wang, Zhibo Chen, Quqing Chen, Jun Teng: “Exploiting repeated patterns for efficient compression of massive models”, Proceedings of the 8th International Conference on Virtual Reality Continuum and its Applications in Industry (VRCAI 2009): 145-150, 2009.

### SUMMARY OF THE INVENTION

When quantizing vector components for encoding, the inventors observed that an acceptable deviation introduced by quantization of the components which are encoded sometimes leads to unacceptable deviations of components which are calculated. The inventors recognized that this is due to a dividing step comprised in the calculation which in case of a divisor close to Zero leads to unacceptable propagation of an error present in the divisor.

Therefore, a method according to claim 1 is proposed for encoding an orientation vector of a connected component, said vector having a pre-determined length and comprising three components.

The methods according the present invention is advantageously used in encoding/decoding of connected component that correspond to instances of a repetitive pattern that occurs in a 3D model.

Said method comprises quantizing and de-quantizing a first and a second component of the vector, and encoding the quantized first and second component and a bit signalling the sign of a third component of said vector, using the pre-determined length and the de-quantized first and second component for determining whether a calculated absolute of an approximation of the third component of said vector is smaller than a first threshold, and if the calculated absolute is smaller than the first threshold, determining, quantizing and encoding a residual between the calculated absolute of the third component and the absolute of the third component.

In an embodiment, said method further comprising encoding of a further orientation vector of said connected component perpendicular to said vector, said further vector having said pre-determined length and comprising three further components, by determining a reconstructed third component using the data encoded according to claim 1, determining that the reconstructed third component is smaller than a second threshold, comparing absolutes of the de-quantized first and second components, wherein, in case absolute of the de-quantized first component is larger than absolute of the de-quantized second component, a bit signalling the sign of a first of the further components is encoded, and, in case absolute of the de-quantized first component is not larger than absolute of the de-quantized second component, a bit signalling the sign of a second of the further components is encoded, and quantizing and encoding a third further component.

In a different embodiment, said method further comprising encoding of a further vector perpendicular to the vector, said further vector having said pre-determined length and comprising three further components, by determining a reconstructed third component using the data encoded according to claim 1, determining that the reconstructed third component is not smaller than a second threshold smaller than the first threshold, using absolutes of the de-quantized first and second components for selecting, quantizing and de-quantizing one of a first and a second of the further components, using a reconstruction of said vector, the pre-determined length and the de-quantized selected further component for calculating the two possible values of the non-selected one of the first and the second further component of said further vector, setting a flag in dependency on which of the calculated two possible values approximates the non-selected further component better, and encoding the quantized selected further component and the flag.

In said different embodiment, said method can further comprise using the pre-determined length, the flag and the de-quantized selected further component for determining whether a calculated further absolute of an approximation of the third further component of said further vector is smaller than the first threshold, and if the calculated further absolute is smaller than the first pre-determined threshold determining, quantizing and encoding a further residual between the calculated absolute and the absolute of the third further component of said further vector.

Said method can but need not comprise storing all data encoded on a non-transitory storage medium.

It is further proposed a storage medium carrying data stored thereon according to the proposed method or one of the embodiments of said method.

And it is proposed a method according to claim 7 for reconstructing an orientation vector of a connected component, said vector having a pre-determined length and comprising three components.

Said reconstructing method comprises decoding a bit signalling the sign of the third component, a first and a second component of the vector and de-quantizing the first and second component, using the pre-determined length and the de-quantized first and second component for determining whether a calculated absolute of an approximation of the third component of said vector is smaller than a first threshold, if the calculated absolute is smaller than the first threshold, determining, decoding and de-quantizing a residual between the calculated absolute of the third component and the absolute of the third component, and using the decoded data for reconstructing the third component of said vector.

In an embodiment, said reconstructing method further comprising decoding of a further orientation vector of said connected component perpendicular to said vector, said further vector having said pre-determined length and comprising three further components, by determining that the reconstructed third component is smaller than a second threshold smaller than the first threshold, comparing absolutes of the de-quantized first and second components, wherein, in case absolute of the de-quantized first component is larger than absolute of the de-quantized second component, a bit signalling the sign of a first of the further components is encoded, and, in case absolute of the de-quantized first component is not larger than absolute of the de-quantized second component, a bit signalling the sign of a second of the further components is encoded, and decoding and de-quantizing a third further component of said vector.

In a different embodiment, said reconstructing method further comprising decoding of a further orientation vector of said connected component perpendicular to said vector, said further vector having said pre-determined length and comprising three further components, by determining that the reconstructed third component is not smaller than a second threshold, decoding a flag and one of the further components and de-quantizing one of the further component, using absolutes of the de-quantized first and second components for determining whether the one of the further components is a first or a second further component of said further vector, using a reconstruction of said vector, the pre-determined length, the flag and the de-quantized one of the further components for calculating that further component of said further vector which the one of the further components is determined not to be, and using the pre-determined length, the de-quantized one further component and the calculated further components for determining an approximation of a third further component.

In said different embodiment, said reconstructing method can further comprise determining that an absolute of the determined approximation of the third further component is smaller than the first threshold, decoding and de-quantizing a further residual and updating the determined approximation using the de-quantized further residual.

Further, a device is proposed comprising a processor for performing one of the proposed methods. Further, the invention provides for a device including an encoder or a decoder for encoding/decoding the orientation vector of a connected component, wherein the connected component corresponds to a instance of a repetitive pattern in a 3D model.

The features of further advantageous embodiments are specified in the dependent claims.

### BRIEF DESCRIPTION OF THE DRAWINGS

Exemplary embodiments of the invention are illustrated in the drawings and are explained in more detail in the following description. The exemplary embodiments are explained only for elucidating the invention, but not for limiting the invention's disclosure or scope defined in the claims.

In the figures:

FIG. 1 exemplarily depicts a flow chart of an embodiment of the encoding method;

FIG. 2 exemplarily depicts a flow chart of an embodiment of the decoding method; and

FIG. 3 shows an exemplary encoder of 3D models according to the present principles; and

FIG. 4 shows an exemplary decoder of 3D models according to the present principles.

### EXEMPLARY EMBODIMENTS OF THE INVENTION

The invention may be realized on any electronic device comprising a processing device correspondingly adapted. A non-exhaustive list of exemplary devices on which the invention can be realized comprises a television, a mobile phone, a personal computer, a digital still camera, a digital video camera, an mp3-player, a navigation system or a car audio system.

The invention can be used for encoding a vector of a pre-determined length independent from any purpose for which the encoded vector may be used.

The exemplary embodiment described in the following relates to modelling of visual objects wherein the encoded vector is an orientation vector, but the invention is not limited thereto.

In table 1, an example of a bit stream format is presented by which a pair of perpendicular normalized vector encoded according to an embodiment of the present invention can be conveyed:

TABLE 1
compr_ith_insta_orient_cartesian class

| class compr_ith_insta_orient_cartesian | | |
|---|---|---|
| { | Num. of bits | Descriptor |
| compr_ith_insta_orient_x0 | bit_num_orient_cartesian( ) | f(bit_num_orient_ |
| | | cartesian( )) |
| compr_ith_insta_orient_y0 | bit_num_orient_cartesian( ) | f(bit_num_orient_ |
| | | cartesian( )) |
| ith_insta_orient_z0_sgn | 1 | |
| if (compute_z0( ) < threshold) { | | |
| compr_ith_insta_orient_z0_res | bit_num_orient_ | f(bit_num_orient_ |
| | res_cartesian( ) | res_cartesian( )) |
| } | | |
| if (compute_z0( ) ≈ 0) { | | |
| compr_ith_insta_orient_z1 | bit_num_orient_cartesian( ) | f(bit_num_orient_ |
| | | cartesian( )) |
| if (abs(ith_x0) < abs(ith_y0)){ | | |
| ith_insta_orient_x1_sgn | 1 | |
| }else{ | | |
| ith_insta_orient_y1_sgn | 1 | |
| } | | |
| }else { | | |
| if (abs(ith_x0) < abs(ith_y0)){ | | |
| compr_ith_insta_orient_x1 | bit_num_orient_cartesian( ) | f(bit_num_orient_ |
| | | cartesian( )) |
| }else { | | |
| compr_ith_insta_orient_y1 | bit_num_orient_cartesian( ) | f(bit_num_orient_ |
| | | cartesian( )) |
| } | | |
| ith_insta_orient_delta_sgn | 1 | |
| if (compute_z1( ) < threshold) { | | |
| compr_ith_insta_orient_z1_res | bit_num_orient_res_cartesian( ) | f(bit_num_orient_ |
| | | res_cartesian( )) |
| } | | |
| } | | |
| } | | |

The orientation of i^{th} instance in Cartesian mode is represented by 2 orthogonal axes (x0, y0, z0) and (x1, y1, z1).

compr_ith_insta_orient_x0: contains the compressed x0 or i^{th} instance's orientation.

compr_ith_insta_orient_y0: contains the compressed y0 of i^{th} instance's orientation.

compr_ith_insta_orient_z0_sgn: a 1-bit unsigned integer indicating the sign of z0 needed for calculating z0 using x0 and y0. 0 for “−” and 1 for “+”.

compr_ith_insta_orient_z0_res: contains the compressed residual of z0 which is calculated by (z0−computer_z0( )).

compr_ith_insta_orient_z1: contains the compressed z1 of i^{th} instance's orientation.

ith_insta_orient_x1_sgn: a 1-bit unsigned integer indicating the sign of x1 needed for calculating x1 using x0, y0. 0 for “−” and 1 for “+”.

ith_insta_orient_y1_sgn: a 1-bit unsigned integer indicating the sign of y1 needed for calculating y1 using x0, y0. 0 for “−” and 1 for “+”.

compr_ith_insta_orient_x1: contains the compressed x1 of i^{th} instance's orientation.

compr_ith_insta_orient_y1: contains the compressed y1 of i^{th} instance's orientation.

ith_insta_orient_delta_sgn: a 1-bit unsigned integer indicating the sign needed for calculating x1 or y1 using x0, y0, z0 and y1 or x1. 0 for “−” and 1 for “+”.

compr_ith_insta_orient_z1_res: contains the compressed residual of z1 which is calculated by (z1−computer_z1( ))

threshold: a threshold widely accepted in compression field.

compute z0( ): compute z0 of the ith instance using x0, y0 and z0 sign.

bit_num_orient_cartesian( ): compute the number of bits for each orientation value in cartesian coordinate system based on QP.

bit_num_orient_res_cartesian( ): compute the number of bits for each orientation residual value in cartesian coordinate system based on QP.

computer_z1( ): compute z1 of the ith instance using x0, y0, z0, x1 and y1.

In table 2, another example of a bit stream format is presented:

TABLE 2
compr_ith_insta_orient_spherical class

| class compr_ith_insta_orient_spherical | | |
|---|---|---|
| { | Num. of bits | Descriptor |
| compr_ith_insta_orient_alpha | bit_num_orient_alpha( ) | f(bit_num_orient_alpha( )) |
| compr_ith_insta_orient_beta | bit_num_orient_beta( ) | f(bit_num_orient_beta( )) |
| compr_ith_insta_orient_gamma | bit_num_orient_gamma( ) | f(bit_num_orient_gamma( ) |
| if (need_correction( )) { | | |
| compr_ith_insta_orient_res | 6*bit_num_orient_ | f(6*bit_num_orient_ |
| | res_cartesian( ) | res_cartesian( )) |
| } | | |
| } | | |

The orientation of ith instance in spherical mode is represented by 3 angles, alpha, beta & gamma.

compr_ith_insta_orient_alpha: contains the compressed alpha of ith instance's orientation.

compr_ith_insta_orient_beta: contains the compressed beta of ith instance's orientation.

compr_ith_insta_orient_gamma: contains the compressed gamma of ith instance's orientation.

compr_ith_insta_orient_res: contains the compressed residual in Cartesian coordinate system of ith instance's orientation.

bit_num_orient_alpha( ): compute the number of bits for each alpha value based on QP

bit_num_orient_beta( ): compute the number of bits for each beta value based on QP

bit_num_orient_gamma( ): compute the number of bits for each gamma value based on QP

need_correction( ): check the orientation, if it is in the edge condition which probably results in a large error, return true; otherwise, return false.

An example where the necessity for the encoding of a normalized vector occurs is representation of orientation of an 3D connected component. Ordinarily, directions are encoded of two of a connected component's orientation axes, in either Cartesian coordinates or spherical coordinates. Because the three orientation axes of a 3D connected component are orthogonal to each other, the third axis can be obtained by computing the cross product of the first two axes.

Denote the three axes by d₀(x0,y0,z0), d₁(x1,y1,z1), and d₂(x2,y2,z2), we have d₀·d₁=0 and d₂=d₀×d₁, then an encoding method of the orientation axes may comprise:
1) Compress x0 and y0.
2) Encoded sign of z0.
3) Compress x1.

Then, y1, z0 and z1 can be calculated using:

z1=sqrt(1−x1²−y1²),

z1=sqrt(1−x1²−y1²), and

0=x0*x1+y0*y1+z0*z1.

The orientation axis d2 is determinable using d₂=d₀×d₁.

But, because the float values of x0, y0 and x1 are quantized before coding a deviation is introduced which due to error propagation in the calculations results in much larger errors in the calculated components.

For example, after compressing the following orientation with 12-bit quantization:

d₀(−0.984644,−0.174418,−0.00737644) and

d₁(−0.121407,−0.714518,−0.689003)

reconstruction with result in

d₀(−0.984462,−0.174202,−0.0220894) and

d₁(−0.121595,0.767049,−0.629961).

The quantization errors of x0, y0 and x1 are acceptable: 0.000182, 0.000216 and 0.000188. However, the errors of calculated values z0, y1 and z1 are 0.01471296, 0.052531 and 0.059042, which is totally unacceptable.

The primary cause of the above is the calculation error of z0. If 1−x0²−y0² is small and thus z0 is small, tiny errors on x or y grow to larger errors of z0 since z0 is the square root of 1−x0²−y0². The invention therefore proposes further encoding a correction in case z0 is small, i.e. its absolute is below a first threshold.

Furthermore, reconstructing z1 comprises a division by z0. This division also leads to unacceptable error propagation in case of z0 being closed to Zero. Similarly, in case x1 is encoded reconstructing y1 comprises a division by (1−x0²). Alternatively, in case y1 is encoded x1 can be reconstructed using a division by (1−y0²).

The invented compression method ensures that a reconstruction of a vector deviates from the vector by no more than a maximum deviation.

As said, some values in the orientation representation can be calculated rather than coded. Unfortunately, this may result in unacceptable errors since the encoded values used for calculation themselves are imprecise because of the quantization. The current invention addresses this problem and proposes a compression method that minimizes the calculation error in that it comprises encoding residual data for those calculated components which are considerably small.

In a specific embodiment where a pair of perpendicular vectors is encoded, the invented coding method comprises encoding a first and a second quantized float component values of one of the pair of vectors and either a first or a second quantized float component value of the other of the pair of vectors. In said specific embodiment two signs bits or flag bits, i.e. to single bits, are further encoded to represent an orientation of the 3D component. To minimize the reconstruction error, the encoding scheme of said specific embodiment is designed based on the following points:
1. Let the denominator in the calculation as large as possible.
2. Special treatment for the cases in which the denominator is extremely small or zero.
3. Automatically identication of cases that probably lead to unacceptable error and transmit the residual data for such cases.

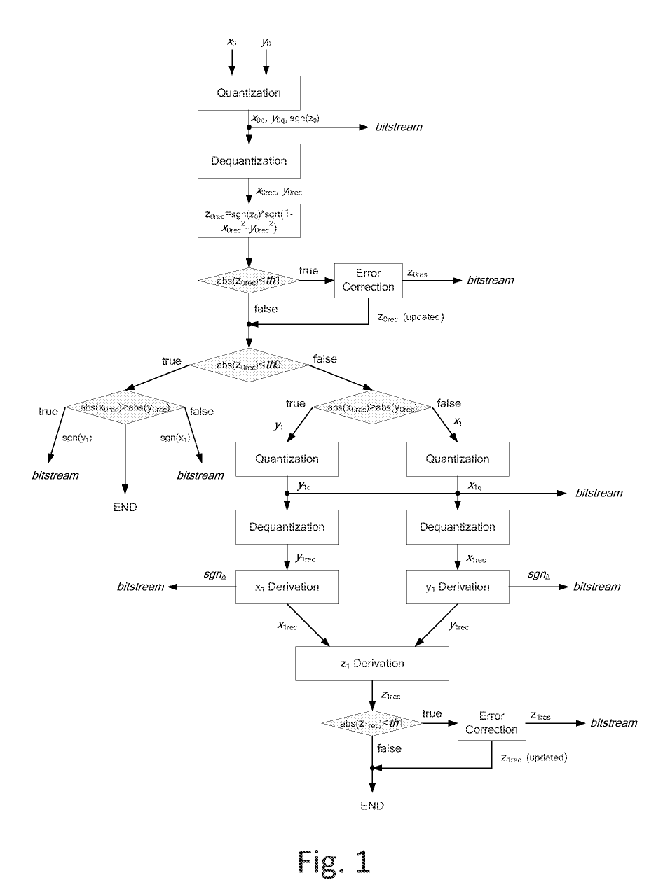

FIG. 1 exemplarily illustrates the encoding process according to said specific embodiment.

The first component x0 of the one vector is always quantized and encoded. At least as long as de-quantization value x0r of first quantized vector component is unequal to 1, a sign bit is further encoded, the sign bit signaling the sign of the third component z0 of the one vector, and the second component y0 of the one vector is further quantized and encoded.

A z0 Derivation module computes an approximation z0a of the third component of the one vector using the predetermined length of the one vector and reconstructions of the encoded data. That is, at least as long as absolute of de-quantization value x0r of first quantized vector component is unequal to 1, the sign bit as well as de-quantization values x0r, y0r of the first and second quantized vector component are used for determining z0a. In case absolute of de-quantization value x0r of first quantized vector component is equal to 1, z0a can be determined as Zero.

An Error Correction module is enabled in case a calculated value for z0a is very small, i.e. smaller than the first threshold, and thus probably inaccurate. In such cases, the encoder further encodes a quantized residual between the original and the approximation z0a. That is, a reconstruction z0r of z0 is either equal to z0a or differs from z0a by the de-quantized residual.

In case the first component of the other vector is encoded, y1 Derivation module computes two possible solutions for the second component of the other vector using the de-quantized first and second quantized float component values x0r, y0r of the one vector as well as the de-quantized first quantized float component value x1r of the other vector:

y1r=(x0r*y0r*x1r+√Δ)/(1−x0r²) or

y1r=(x0r*y0r*x1r−√Δ)/(1−x0r²)

In these equations, Δ equals z0r²*(1−x0r²−y0r²) with z0r being the possibly residual corrected reconstruction.

Similarly, in case the second component of the other vector is encoded, x1 Derivation module computes two possible solutions for the first component of the other vector using the de-quantized first and second quantized float component values x0r, y0r of the one vector as well as the de-quantized second quantized float component value y1r of the other vector:

x1r=(x0r*y0r*y1r+√Δ)/(1−y0r²) or

x1r=(x0r*y0r*y1r−√Δ)/(1−y0r²)

In these equations, Δequals z0r²*(1−x0r²−y0r²) with z0r being the possibly residual corrected reconstruction.

In case is absolute of z0r very small, i.e. smaller than a second threshold which is even smaller than the first threshold, neither x1 Derivation module nor y1 Derivation module is activated. Instead z1 is quantized and encoded. In addition, a further sign bit is encoded, the further sign bit indicating the sign of that one of the reconstructed first and second components of the other vector which has the smaller absolute value.

Whether x1 Derivation module or y1 Derivation module is activated in case the absolute of z0r is not smaller than the second threshold depends on the relation of the absolutes of reconstructed first and second components x0r and y0r of the one vector. In case abs(x0r)>abs(y0r), x1 is quantized and encoded and the y1 Derivation module is activated. In case abs(x0r)≦abs(y0r), y1 is quantized and encoded and the x1 Derivation module is activated. Since, each of the x1 Derivation module and the y1 Derivation module provides to possible solutions, a flag bit is further encoded to indicate a decoder the solution to be used.

A z1 Derivation module computes an absolute of z1, in case z0 is below said first threshold, using square root function sqrt(·), the predetermined length of the one vector as well as the de-quantized first and second quantized float component values of the one vector:

z1=sqrt(1−x1r²−y2r²)

In case z0 is not below said first threshold, absolute of z1 is calculated as follows using absolute function abs(·):

z1=abs((−x0r*x1r−y0r*y1r)/z0)

The Error Correction module can also be enabled in case a calculated value for z1 is small and thus probably inaccurate. If the Error Correction module is also enabled in case the calculated value for z1 is small, the encoder further encodes a further quantized residual between the original and the calculated value of z1.

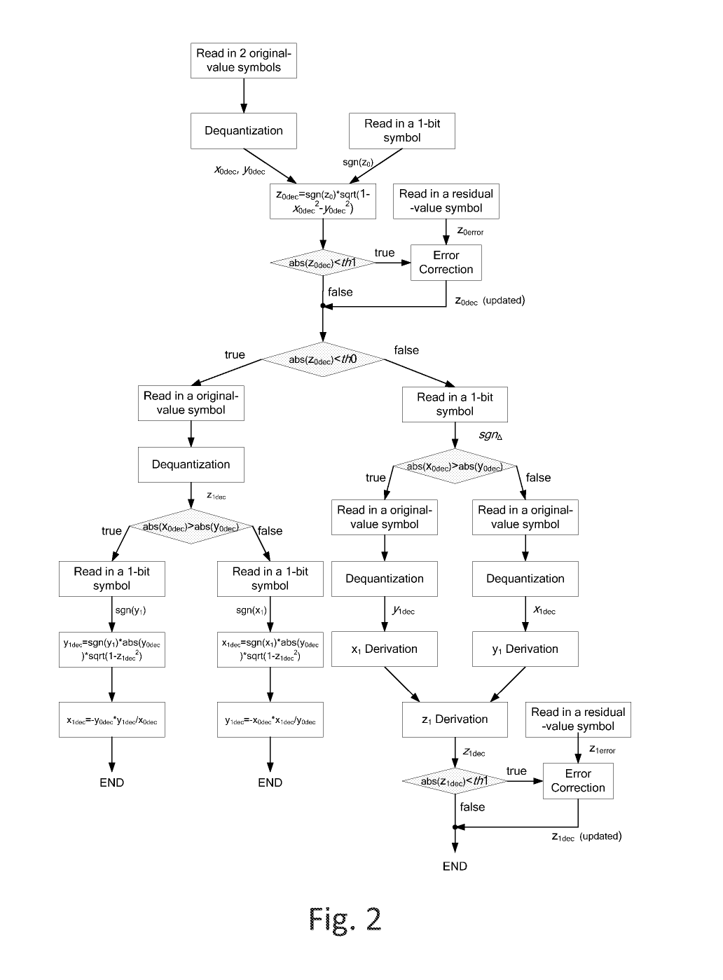

FIG. 2 exemplarily illustrates the decoding process according to said specific embodiment.

The first x0r float component value of the one vector is always decoded and de-quantized. Further, a flag bit is always decoded. At least as long as de-quantization value x0r of the first quantized vector component is unequal to One, a sign bit is further decoded, the sign bit signaling the sign of the third component z0r of the one vector, and the second component y0 of the one vector is further decoded and de-quantized.

A z0 Derivation module computes an approximation z0a of the third component of the one vector using the predetermined length of the one vector and the decoded and de-quantized data. That is, at least as long as absolute of de-quantization value x0r of first quantized vector component is unequal to 1, the sign bit as well as de-quantization values x0r, y0r of the first and second quantized vector component are used for determining z0a. In case absolute of de-quantization value x0r of first quantized vector component is equal to 1, y0r and z0a, both, can be determined as Zero.

An Error Correction module is enabled in case a calculated value for z0a is very small, i.e. smaller than the first threshold, and thus probably inaccurate. In such cases, the decoder further decodes and de-quantizes the quantized residual between the original and the approximation z0a. That is, a reconstruction z0r of z0 is either equal to z0a or differs from z0a by the de-quantized residual.

In case z0r is not smaller than the second threshold smaller than the first threshold and absolute of x0r is smaller than absolute of y0r, the second quantized component of the other vector is decoded and de-quantized for obtaining y1r wherein the flag bit indicates which one of two possible solutions to be used for calculating the first component of the other vector. Then, x1r and z1r are calculated.

In case z0r is not smaller than the second threshold smaller than the first threshold and absolute of x0r is smaller than absolute of y0r, y1 Derivation module uses the flag bit for selecting one of the two possible solutions for computing the second component of the other vector:

y1r=(x0r*y0r*x1r+√Δ)/(1−x0r²) or

y1r=(x0r*y0r*x1r−√Δ)/(1−x0r²)

In these equations, Δequals z0r²*(1−x0r²−y0r²) with z0r being the possibly residual corrected reconstruction.

In case z0r is not smaller than the second threshold smaller than the first threshold and absolute of x0r is not smaller than absolute of y0r, the first quantized component of the other vector is decoded and de-quantized for obtaining x1r wherein the flag bit indicates which one of two possible solutions to be used for calculating the second component of the other vector. Then, y1r and z1r are calculated.

In case z0r is not smaller than the second threshold smaller than the first threshold and absolute of x0r is not smaller than absolute of y0r, x1 Derivation module uses the flag bit for selecting one of two possible solutions for calculating the first component of the other vector:

x1r=(x0y*y0r*y1r+√Δ)/(1−y0r²) or

x1r=(x0r*y0r*y1r−√Δ)/(1−y0r²)

In these equations, Δ equals z0r²*(1−x0r²−y0r²) with z0r being the possibly residual corrected reconstruction.

In case z0r is smaller than the second threshold smaller than the first threshold and absolute of y0r is smaller than absolute of x0r, the third quantized component of the other vector is decoded and de-quantized for obtaining z1r, the flag bit is used for determining sign(y1r) of y1r and x1r and y1r are calculated:

y1r=sign(y1r)*abs(x0r)√(1−z1r²)

x1r=−x0r*x1r/y0r

In case z0r is smaller than the second threshold smaller than the first threshold and absolute of y0r is not smaller than absolute of x0r, the third quantized component of the other vector is decoded and de-quantized for obtaining z1r, the flag bit is used for determining sign(x1r) of x1r and y1r are calculated:

x1r=sign(x1r)*abs(x0r)√(1−z1r²)

y1r=−x0r*x1r/y0r

In case z1r does not result from decoding and de-quantizing but from calculation and has an absolute value below the first threshold, the Error Correction module can be enabled. In such cases the decoder further decodes and de-quantizes the further quantized residual between the original and z1r and corrects z1r according to the de-quantized further residual.

Though the specific embodiment describes the invention in terms of Cartesian coordinates, the invention is not limited thereto. In spherical coordinates a similar problem occurs for angles closed to π/2, also written as 90° or PI/2. That is, it is proposed to encode a residual of a calculated angle of a normalized vector in case absolute of said calculated angle does not differ from π/2 by a threshold.

As previously discussed, the present principles may be advantageously applied in the context of encoding 3D models repetitive structures. To efficiently encode 3D models, repetitive structures may be organized into patterns and instances, wherein an instance is represented as a transformation of a corresponding pattern, for example, using a pattern ID of the corresponding pattern and a transformation matrix which contains information on translation, rotation, and scaling.

When an instance is represented by a pattern ID and a transformation matrix, the pattern ID and the transformation matrix are to be compressed when compressing the instance. Consequently, an instance may be reconstructed through the pattern ID and the decoded transformation matrix, that is, an instance may be reconstructed as transformation (from the decoded transformation matrix) of a decoded pattern indexed by the pattern ID.

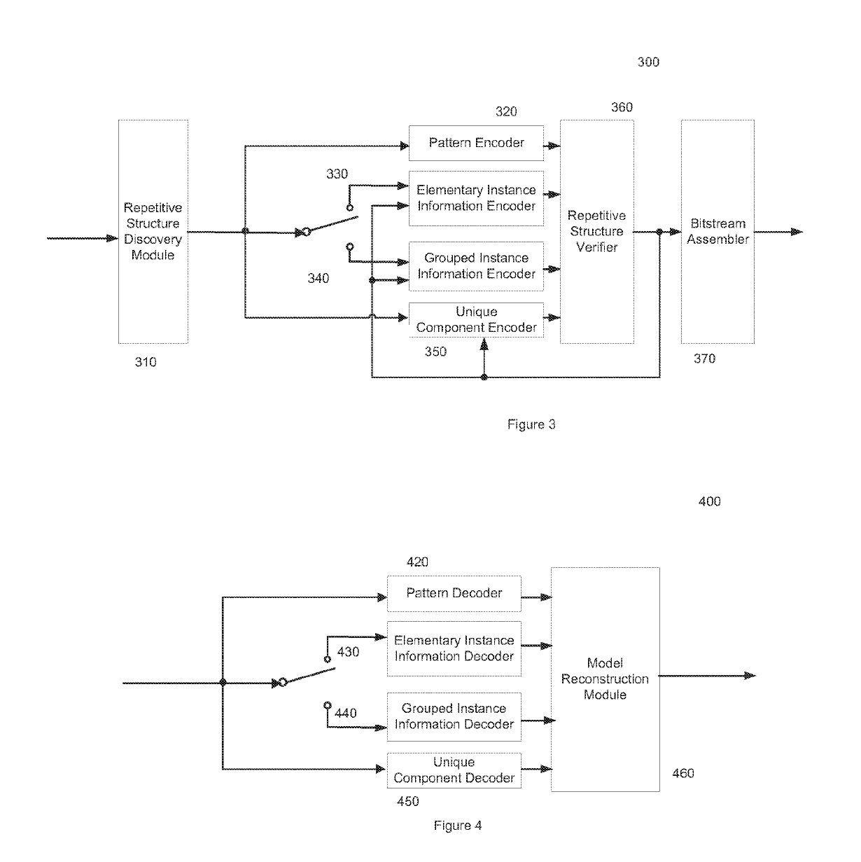

FIG. 3 depicts a block diagram of an exemplary 3D model encoder 300. The input of apparatus 300 may include a 3D model, quality parameter for encoding the 3D model and other metadata. The 3D model first goes through the repetitive structure discovery module 310, which outputs the 3D model in terms of patterns, instances and unique components. A pattern encoder 320 is employed to compress the patterns and a unique component encoder 350 is employed to encode the unique components. For the instances, the instance component information is encoded based on a user-selected mode. If instance information group mode is selected, the instance information is encoded using grouped instance information encoder 340; otherwise, it is encoded using an elementary instance information encoder 330. The encoded components are further verified in the repetitive structure verifier 360. If an encoded component does not meet its quality requirement, it will be encoded using unique component encoder 350. Bitstreams for patterns, instances, and unique components are assembled at bitstream assembler 370.

FIG. 4 depicts a block diagram of an exemplary 3D model decoder 400. The input of apparatus 400 may include a bitstream of a 3D model, for example, a bitstream generated by encoder 300. The information related to patterns in the compressed bitstream is decoded by pattern decoder 420. Information related to unique components is decoded by unique component decoder 450. The decoding of the instance information also depends on the user-selected mode. If instance information group mode is selected, the instance information is decoded using a grouped instance information decoder 440; otherwise, it is decoded using an elementary instance information decoder 430. The decoded patterns, instance information and unique components are reconstructed to generate an output 3D model at model reconstruction module 460.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

In principle, the disclosed invention can also be applied to other data compression areas. The invention results in a unique bitstream format.

While the bitstream embeds all the transformation data, it is efficient and may address several applications, where sometimes either bitstream size or decoding efficiency or error resilience matters the most. Therefore, two mode options are disclosed for how to put the transformation data of one instance, i.e. its position, orientation and scaling factor, in the bitstream. In the first mode (Option A), the position, orientation and possible scaling factor of one instance are packed together in the bitstream. In the second mode (Option B), the positions, orientations or possible scaling factors of all instances are packed together in the bitstream.

It will be understood that the present invention has been described purely by way of example, and modifications of detail can be made without departing from the scope of the invention.

Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections.

Reference numerals appearing in the claims are by way of illustration only and shall have no limiting effect on the scope of the claims.

1. Method for encoding an orientation vector of a connected component, said vector having a pre-determined length and comprising three components, said method comprising
Quantizing and de-quantizing a first and a second component of the vector, and encoding the quantized first and second component and a bit signalling the sign of a third component of said vector,
using the pre-determined length and the de-quantized first and second component for determining whether a calculated absolute of an approximation of the third component of said vector is smaller than a first threshold,
and if the calculated absolute is smaller than the first threshold, determining, quantizing and encoding a residual between the calculated absolute of the third component and the absolute of the third component.

2. Method according to claim 1, said method further comprising encoding of a further orientation vector of said connected component perpendicular to said vector, said further vector having said pre-determined length and comprising three further components, by
determining a reconstructed third component using the data encoded according to claim 1,
determining that the reconstructed third component is smaller than a second threshold,
comparing absolutes of the de-quantized first and second components, wherein,
in case absolute of the de-quantized first component is larger than absolute of the de-quantized second component, a bit signalling the sign of a first of the further components is encoded, and,
in case absolute of the de-quantized first component is not larger than absolute of the de-quantized second component, a bit signalling the sign of a second of the further components is encoded, and
quantizing and encoding a third further component.

3. Method according to claim 1, said method further comprising encoding of a further vector perpendicular to the vector, said further vector having said pre-determined length and comprising three further components, by
determining a reconstructed third component using the data encoded according to claim 1,
determining that the reconstructed third component is not smaller than a second threshold smaller than the first threshold,
using absolutes of the de-quantized first and second components for selecting, quantizing and de-quantizing one of a first and a second of the further components,
using a reconstruction of said vector, the pre-determined length and the de-quantized selected further component for calculating the two possible values of the non-selected one of the first and the second further component of said further vector,
setting a flag in dependency on which of the calculated two possible values approximates the non-selected further component better, and
encoding the quantized selected further component and the flag.

4. Method according to claim 3, said method further comprising
using the pre-determined length, the flag and the de-quantized selected further component for determining whether a calculated further absolute of an approximation of the third further component of said further vector is smaller than the first threshold,
and if the calculated further absolute is smaller than the first pre-determined threshold determining, quantizing and encoding a further residual between the calculated absolute and the absolute of the third further component of said further vector.

5. Method according to claim 1, further comprising storing all data encoded on a non-transitory storage medium.

6. Non-transitory computer readable storage medium wherein the storage medium carries data stored thereon according to the method of claim 5.

7. Method for reconstructing an orientation vector of a connected component, said vector having a pre-determined length and comprising three components, said method comprising
decoding a bit signalling the sign of the third component, a first and a second component of the vector and de-quantizing the first and second component,
using the pre-determined length and the de-quantized first and second component for determining whether a calculated absolute of an approximation of the third component of said vector is smaller than a first threshold,
if the calculated absolute is smaller than the first threshold, determining, decoding and de-quantizing a residual between the calculated absolute of the third component and the absolute of the third component, and
using the decoded data for reconstructing the third component of said vector.

8. Method according to claim 7, said method further comprising reconstructing of a further orientation vector of said connected component perpendicular to said vector, said further vector having said pre-determined length and comprising three further components, by
determining that the reconstructed third component is smaller than a second threshold smaller than the first threshold,
comparing absolutes of the de-quantized first and second components, wherein,
in case absolute of the de-quantized first component is larger than absolute of the de-quantized second component, a bit signalling the sign of a first of the further components is encoded, and,
in case absolute of the de-quantized first component is not larger than absolute of the de-quantized second component, a bit signalling the sign of a second of the further components is encoded,
and decoding and de-quantizing a third further component of said vector.

9. Method according to claim 7, said method further comprising reconstructing of a further orientation vector of said connected component perpendicular to said vector, said further vector having said pre-determined length and comprising three further components, by
determining that the reconstructed third component is not smaller than a second threshold,
decoding a flag and one of the further components and de-quantizing one of the further component,
using absolutes of the de-quantized first and second components for determining whether the one of the further components is a first or a second further component of said further vector,
using a reconstruction of said vector, the pre-determined length, the flag and the de-quantized one of the further components for calculating that further component of said further vector which the one of the further components is determined not to be, and
using the pre-determined length, the de-quantized one further component and the calculated further components for determining an approximation of a third further component.

10. Method according to claim 9, said method further comprising
determining that an absolute of the determined approximation of the third further component is smaller than the first threshold,
decoding and de-quantizing a further residual and
updating the determined approximation using the de-quantized further residual.

11. Device comprising a processor for performing the method of claim 1.

12. Device comprising: a repetitive structure discovery module that determines a orientation vector associated with a connected component, wherein said connected component corresponds to an instance of a pattern, the pattern corresponding to a repetitive structure that occurs in a 3D model; and an encoder that performs the method of claim 1 to encode said orientation vector.

13. Device comprising: a decoder that decodes a orientation vector encoded according to the method of claim 7, wherein said connected component corresponds to an instance of a pattern, the pattern corresponding to a repetitive structure that occurs in a 3D model; and a model reconstruction module that generates the 3D model including the connected component.

14. Method according to claim 1, wherein said connected component corresponds to an instance of a pattern, the pattern corresponding to a repetitive structure that occurs in a 3D model, and further comprising the step of determining said orientation vector associated with said connected component.

15. Method according to claim 7, wherein said connected component corresponds to an instance of a pattern, the pattern corresponding to a repetitive structure that occurs in a 3D model, and further comprising the step of generating said 3D model including said connected component.
